(19) United States
(12) Patent Application Publication
(10) Pub. No.: US 2018/0254127 A1
(43) Pub. Date: Sep. 6, 2018

(54) DATA CABLE, MOTOR VEHICLE HAVING THE DATA CABLE AND METHOD OF PRODUCING THE DATA CABLE

(71) Applicant: LEONI KABEL GMBH, Nuernberg (DE)

(72) Inventors: DOMINIK DORNER, PLEINFELD (DE); MICHAEL FEIST, SCHWABACH (DE); BERND JANSSEN, FRIESOYTHE OT NEUSCHARREL (DE); ERWIN KOEPPENDOERFER, SCHWABACH (DE); JOHANNES NACHTRAB, WINDSBACH (DE); RAINER POEHMERER, WINKELHAID (DE)

(21) Appl. No.: 15/972,478

(22) Filed: May 7, 2018

Related U.S. Application Data
(63) Continuation of application No. PCT/EP2016/076583, filed on Nov. 3, 2016.

(30) Foreign Application Priority Data
Nov. 6, 2015 (DE) 102015221906.2

(51) Int. Cl. H01B 11/20; H01B 11/00; H01B 11/18; H01B 13/016; H01B 13/02

(52) U.S. Cl. CPC H01B 11/20; H01B 11/002; H01B 13/0207; H01B 13/0165; H01B 11/1847

(57) ABSTRACT

A data cable contains a cable core having a plurality of core pairs. Each of the core pairs are composed of two cores directly surrounded by a pair shielding. The pair shielding has a conductive exterior surrounding a core pair and being oriented outward. An overall shield surrounds the cable core and lies on the conductive exterior of the pair shielding and is thereby electrically connected to the cable core.

### CROSS-REFERENCE TO RELATED APPLICATION

This is a continuation application, under 35 U.S.C. § 120, of copending international application No. PCT/EP2016/076583, filed Nov. 3, 2016, which designated the United States; this application also claims the priority, under 35 U.S.C. § 119, of German patent application DE 10 2015 221 906.3, filed Nov. 6, 2015; the prior applications are herewith incorporated by reference in their entireties.

### BACKGROUND OF THE INVENTION

### Field of the Invention

The invention relates to a data cable, having a cable core, which contains a number of core pairs, wherein each core pair has two cores, preferably parallel, that are surrounded by a pair shielding. The invention additionally relates to the use of such a data cable in a means of transport for land, water, space and/or air, such as, for example, a motor vehicle, aircraft, ships, boats or air-cushion vehicles, etc. In order to avoid unnecessary repetitions, in the following reference is made to the motor vehicle, but no limitation is thereby intended with respect to use in a means of transport.

Such data cables are used in particular for high-speed data transmissions, especially for symmetrical data transmissions. In the case of such symmetrical data transmissions, a signal is fed into one core of the core pair, and a signal that is inverted in relation thereto is fed into the other core. At the receiver side, the two signals are summed together, such that external interferences cancel each other out. Such data cables for computer networks are offered by the applicant, under the brand name ParalLink.

Owing to the increase in communication technology also within motor vehicles, the demand for such high-speed data lines is also growing in the automotive sector. Generally in this case, besides a high cost pressure, it is also sought to keep structural space and weight to a minimum.

Frequently, for data transmission, two core pairs are combined in a common data cable. In order to ensure data transmission that is reliable and free from interference, shieldings are required in this case for high-speed data transmissions at data transmission rates in the GB range. The shieldings in this case must be electrically contacted, at the cable end, to the point of connection to components, e.g. in a plug region. This is difficult, in particular, in the case of foil shields that are frequently used for such data lines.

European patent application EP 2 112 669 A2, corresponding to U.S. patent publication No. 2009/0260847, discloses a data cable having a shielded core pair, in which the pair shielding is formed by a metal-clad carrier foil. The carrier foil in this case is realized, not in a wound manner, but such that it is folded longitudinally, the foil being turned over in the region of overlap of the longitudinal edges of the foil, such that a conductive metal side facing inward toward the core pair is oriented outward. Arranged in this region is a filler wire that electrically contacts the metal side that is oriented outward there. By means of this filler wire, the shielding can then easily be contacted in the plug at the end, for example by means of conventional crimp technology.

### BRIEF SUMMARY OF THE INVENTION

Proceeding therefrom, the invention is based on the object of specifying a data cable, in particular for symmetrical high-speed data transmission at data transmission rates in the GB range, in which reliable data transmission is achieved with, at the same time, a small space requirement and low weight, and that is also easily fabricated.

The object is achieved, according to the invention, by a data cable having the features of the independent data cable claim, and by a method having the features of the independent method claim. The data cable contains a cable core, each core pair having two cores, which are preferably arranged parallel to each other and surrounded by a pair shielding. The respective core pair in this case is composed, in particular, of the two cores, and is directly surrounded by the pair shielding. The shielded core pair thus does not have any further components surrounded by the pair shielding, such as filling elements or further cores, etc. Number of core pairs, in the present case, is to be understood to mean at least one core pair, but preferably a plurality of core pairs, and in particular two.

The respective pair shielding in this case has a conductive exterior, i.e. that is oriented outward, surrounding the core pair. This exterior therefore completely surrounds the core pair and is oriented outward over the entire circumference. In addition, the cable core as a whole is surrounded by an overall shield that lies on this conductive, outwardly oriented exterior of the pair shield and is thereby electrically connected to the latter.

This design achieves the particular advantage that, owing to the direct electrical connection between the conductive exterior of the respective pair shielding and the overall shield, additional elements, in particular an additional filler wire, can be omitted, and also expediently are omitted. At the same time, the overall shield enables simple fabrication and contacting of the overall shield at the end of the cable, for example in the case of connection to a component, or also in a plug. Moreover, owing to the omission of a filler wire, there is a saving of material, resulting both in a reduction of the necessary structural space and in savings of weight and cost.

The cores of a respective core pair in this case preferably run parallel to each other, i.e. without a twist. Interferences resulting from twisting are thereby avoided.

In an expedient design, if a plurality of core pairs is used, the respective pair shields in this case lie against each other in an electrically conductive manner. Unlike conventional data cables, therefore, there is no galvanic isolation between the individual core pairs. Since the pair shields are simultaneously conductively connected to the overall shield, a conductive contact over as large an area as possible is ensured between the individual shielding elements, such that, overall, a reliable shielding is achieved. All shielding elements are therefore at the same potential.

In an expedient development, the core pairs respectively provided with a pair shielding, in particular two core pairs, are connected to each other to form a stranded bundle. This stranded bundle in this case preferably forms the cable core. Alternatively, the cable core may also be formed by yet further elements, together with the shielded core pairs, preferably as a common stranded bundle. The further elements may thus be jointly stranded with the core pairs. The stranding achieves the effect, firstly, of an overall high (bending) flexibility of the data cable, this being advantageous, in particular, in applications in means of transport.

In an expedient design, a respective pair shielding is wound around the respective core pair. The pair shielding therefore has a shielding element spiraled around the respective core pair. Reliable shielding overall is thereby ensured, even in the case of flexural stress.

Expediently, the pair shieldings of a plurality of core pairs, and preferably all core pairs, of the cable core are wound in the same direction. This measure achieves the particular advantage that, particularly in combination with the core pairs stranded to form a stranded bundle, with an appropriate stranding direction, a quasi-compression of the individual pair shieldings is achieved. The latter are therefore reliably fixed to the respective core pair by the forces applied during the stranding process.

Owing to this fixing of the pair shielding achieved by the stranding process, for the purpose of saving structural space and costs it is also possible to omit an otherwise necessary banding foil. Accordingly, a preferred configuration therefore also omits such an additional insulating and stabilizing banding foil around a respective pair shielding, or also around the entire stranded bundle.

A further particular advantage of the overall stranding consists in that this also ensures close and particularly tight wrapping of a respective core pair with the shielding foil, such that, overall, a reliable shielding is realized and the transmission properties of the two core pairs are thereby improved.

In order to achieve this, a respective pair shielding in this case is wound, in particular, so as to run in the same direction as a stranding direction of the stranded bundle. The pair shielding and the overall stranding are therefore realized in the same manner, with the same direction of lay. Preferably, furthermore, a lay length of the pair shielding is less than a total lay length of the stranded bundle.

In principle, it is possible to use any shielding elements for the respective pair shielding, for example a spiral shield composed of individual wires that go around the pair in the form of a spiral, a braided shield, a foil shield, or also combinations thereof. Expediently, however, only a shielding foil is provided as a pair shielding, i.e. the pair shielding is formed by the shielding foil. This is wound, in particular, around the core pair in the manner of a banding. Adjacent foil portions in this case preferably overlap one another. This shielding foil is, in particular, a plastic foil that is metal-clad on one or both sides, in particular an aluminum-clad plastic foil. Alternatively, a metal foil is used. The use of a simple shielding foil is rendered possible, in particular, in combination with the stranded core pairs, since in this case the shielding foil is, as it were, fixed on the core pair by the stranding, as previously described. Further fixing of the banded shielding foil is therefore not necessary, and preferably also not provided. The thickness of the shielding foil in this case is usually in the range of from some 1/100 mm to typically maximally 1/10 mm, e.g. 1/20 mm. In all cases, the shielding element is applied, in particular, directly around the two cores, i.e. without the interposition of further separate elements such as, for example, in particular, foils or layers.

As an alternative, or also in addition, to the shielding foil, a conductive sheath layer is realized for the purpose of realizing the pair shielding. The sheath layer is preferably realized as an extruded-on sheath, and can thus be produced inexpensively. The sheath in this case is composed, in particular, of a conductive plastic. Such a plastic is achieved, for example, by the addition and embedding of conductive particles into a plastic matrix.

The conductive sheath in this case surrounds the respective core pair. As an alternative to this, the conductive sheath surrounds a respective core insulation, and therefore forms an outer concentric core sheath of a respective core. The conductive sheath layers of the two cores of the core pair touch each other, and thereby realize the pair shielding. In the case of realization with the conductive sheath layer, an additional shielding element such as, for example, an additional shielding foil, etc., is preferably omitted.

The overall shield surrounding the cable core is preferably realized as a braided shield, spiral shield or, also, as a foil shield or a combination thereof. In particular, however, it contains at least one braid or a spiral shield element, which is each composed of a multiplicity of individual wires that are braided or spiraled together. These may be combined with a further shielding foil. Such a braided shield or spiral shield is easily fabricated, owing to high stability, as compared with a shielding foil.

The cable core is not necessarily limited to the use of core pairs for data transmission. In an expedient design, the cable core, besides having the core pairs, has yet further elements such as, for example, filling strands, in order to set a desired geometry or, in particular, roundness. Additionally or alternatively, integrated besides the core pairs are electrical supply lines, which thus serve to supply electric power to components, and which usually have a significantly greater line cross section than the cores for the data transmission. In this case, these supply lines are themselves shielded or, also, unshielded. Besides the core pairs, also integrated, for example, are further electrical or optical data transmission elements. Overall, in the case of such embodiment variants, the data cable is a hybrid cable having differing functions. These further elements are preferably arranged in addition to the shielded core pairs, i.e. outside of the pair shielding in each case.

Expediently, the data cable is a prefabricated data cable, there being a connection element, in particular a plug, contacted at the end. The connection element in this case has a connection to frame, which is preferably connected solely to the overall shield. The connection to the frame therefore effects the shield interfacing of the individual pair shields. Individual direct contacting of the individual pair shields, i.e. of their electrical-mechanical connection to the connection element, is preferably not effected. The contacting is effected only directly, via the overall shield.

Such a data cable is used, in particular, in a motor vehicle, but is not limited to applications in the automotive sector.

In a preferred design, for the purpose of producing such a data cable, the pair shielding is realized by a wrapping or banding, especially as a shielding foil, wherein the winding direction of the banding runs in the same direction as a stranding direction of the stranded bundle of the core pair. This measure achieves the effect that the pair shielding is pulled more tightly radially, and thus remains fixedly wound around the core pair. In particular, this makes it possible to omit a further plastic foil for fixing the pair shielding in place.

Preferably, the pair shieldings in this case are applied during the stranding process for the purpose of realizing the stranded bundle, without the individual core pairs first being banded with the shielding foil. There is thus no separate banding process. The stranding process is used for the purpose of banding. The shielding foil in this case is supplied parallel to the respective core pair, running together into the stranding machine.

Other features which are considered as characteristic for the invention are set forth in the appended claims.

Although the invention is illustrated and described herein as embodied in a data cable and use of the data cable in a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE SEVERAL VIEWS OF THE DRAWING

FIG. 1 is a diagrammatic, cross sectional view through a data cable according to the invention; and

FIG. 2 is a perspective view of the data cable according to FIG. 1, with individual layers of the cable exposed.

### DETAILED DESCRIPTION OF THE INVENTION

In the figures, parts that have the same function are denoted by the same references.

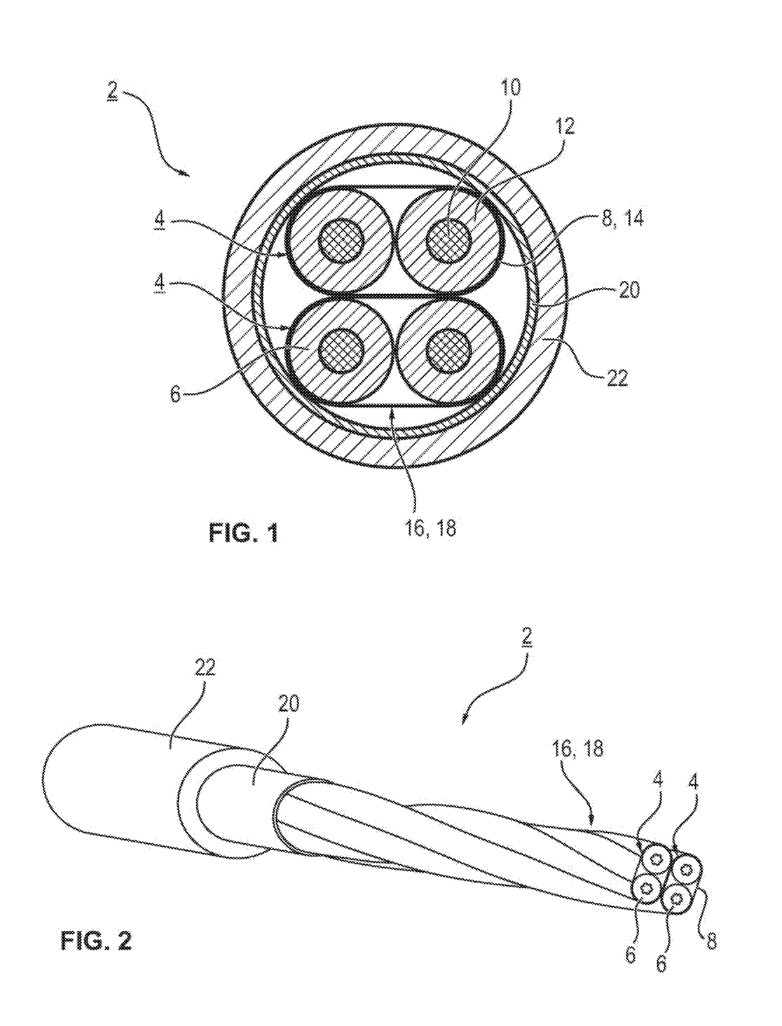

Referring now to the figures of the drawings in detail and first, particularly to FIG. 1 thereof, there is shown a data cable 2 used in general for transmitting symmetrical data signals, and is suitable for a reliable data transmission at data rates of preferably greater than 100 MB per second, and preferably of greater than 1 GB per second. The data cable 2 preferably has at least two core pairs 4 that are each formed by two cores 6, which are surrounded by a pair shielding 8. Expediently, the data cable 2 has precisely two core pairs 4, as represented in the figures. The individual cores 6 in this case are run parallel to each other, i.e. the cores 6 of a core pair 4 are stranded together. A respective core 6 has, and is preferably composed of, an electrical conductor 10 and a core insulation 12 in each case. The conductor 10, in particular, is a stranded conductor having stranded individual strands, preferably of copper. Other materials, in particular copper alloys, aluminum, aluminum alloys, etc., may also be used. The individual strands may also be coated. The conductor 10 may also be a solid conductor. The core insulation 12 forms a dielectric. The core insulation 12 is preferably composed of a solid plastic sheath that is extruded-on. Expediently, polypropylene is used in this case. In principle, however, other suitable materials may also be used. As an alternative to a solid design, the core insulation 12 is realized as a foamed sheath.

In the case of the exemplary embodiment represented, the core pairs 4 are composed of two individual cores 6 that are not connected to each other. As an alternative to this, a respective core pair 4 is realized as an, in particular, extruded twin, i.e. the two cores 6 are, as it were, part of a two-core strip line. In the case of the latter, the two conductors 10 are inserted in a common insulation sheath. For this purpose, preferably in one work operation, a common insulation mantel is applied, in particular by means of extrusion, to the conductors 10 that run parallel next to each other, such that the twin line is produced.

The pair shielding 8 is, in particular, a shielding foil 14, which is preferably realized as a plastic foil that is metal-clad on one side. The plastic foil in this case has a metallic, conductive side, which is oriented outward. As an alternative to a carrier foil clad on one side, a foil that is clad on both sides, or a metal foil, may also be used. The shielding foil 14 is expediently wound around the core pair 4, in the manner of a banding. As an alternative to this, a longitudinally folded shielding foil is used, such as that disclosed, for example, by the document published, European patent application EP 2 112 669 A2 cited at the beginning.

As an alternative to the shielding foil 14, a conductive sheath layer, not represented in greater detail here, is applied, in particular extruded-on. The latter preferably surrounds the two cores 6 of the core pair 4 jointly. Alternatively, each core 6 is provided with such a conductive extruded sheath layer.

The core pairs 4 provided with the pair shielding 8 are stranded together to form a stranded bundle 16. In the exemplary embodiment, this stranded bundle 16 simultaneously forms a cable core 18. In the exemplary embodiment, no further elements are provided. Alternatively, further elements may also be integrated. These are, for example, electrically/optically functionless filling strands and/or the cable core 18 is realized as a hybrid cable core 18, in which, besides the core pairs, further electrical and/or optical transmission elements are also integrated. In the case of a hybrid structure, the further elements are preferably likewise part of the stranded bundle 16.

As a result of the stranding of the core pairs 4, good flexibility of the data cable 2 as a whole is achieved. Furthermore, as a result of the stranding, the transmission properties for data transmission are positively affected, in particular in the case of (bending) movements of the data cable 2.

The banded-on shielding foil 14 in this case is expediently banded-on in the same direction as the core pairs 4 are stranded together. A direction of lay of the shielding foil 14 therefore corresponds to a direction of lay of the stranded bundle 16. As a result of this measure, in a preferred design, the banded-on shielding foils 14 are therefore fixed on the core pairs 4, such that separate fixing means, in particular insulating intermediate foils, can be omitted, and are also omitted.

The shielding foil 14 in this case is optionally first banded around a respective core pair in a separate step. Alternatively, the shielding foil 14 is applied during the overall stranding to produce the stranded bundle 16, in that they are inserted concomitantly, around respectively two parallel cores. In the latter case, there is no separate banding process. Thus, for the banding of the shielding foil 14, the process of stranding the core pairs 4 to form the stranded bundle 16 is used.

A further particular advantage consists in that, as a result of the overall stranding to form the stranded bundle 18, a close and particularly tight winding of the respective core pair 4 with the shielding foil 14 is ensured, such that, overall, a reliable shielding is ensured.

In addition, an overall shield 20, which surrounds the cable core 18 as a whole, is also applied around the cable core 18, or the stranded bundle. This overall shield 20 is preferably a braided shield. The overall shield 20 in this case lies directly on the respective pair shields 8, and electrically contacts the latter. Connection of the pair shields 8 to a (frame) contact is effected, in a manner not represented in greater detail here, via this overall shield 20. In this case, use may be made of conventional, easily fabricated shield contacting methods, e.g. crimping. Moreover, the overall shield 20 also serves to further improve the shielding, in particular to improve the EMC property.

Finally, to protect against external influences, an external cable sheath 22 is also realized. The latter forms an outer insulating sheath, and is composed, in particular, of PVC or of another suitable insulating material.

The data cable 2 described here is characterized, on the one hand, by the electrical contacting between the pair shields 8 and the overall shield 20, rendering possible simplified contacting of the shielding by means of the overall shield 20. On the other hand, the data cable 2 is characterized by the fact that the shielding foil 14 for the respective core pair 4 is applied in the same manner as the overall stranding of the cable core 18, i.e. the shielding foil 14 and the stranded bundle have, in particular, the same direction of lay. This achieves the advantage that a simple shielding foil, in particular an aluminum-clad shielding foil, can be used without additional fixing means being required. By means of the overall stranding, the banded shielding foil is firmly fixed on the core pairs 4. In addition, this also results overall in a better, reliable shielding, in particular also in the case of movements of the data cable 2.

Overall, a data cable 2 having good transmission properties for high-frequency, in particular symmetrical, data transmission is achieved by the structure described here. Various elements that are usual in the prior art are omitted in this case. This applies, in particular, to a separate filler wire, and also to an additionally stabilizing foil for the shielding foil 14. As a result, the data cable can be of an overall compact design, such that it takes up little structural space. At the same time, the weight is thereby reduced.

1. A data cable, comprising:
a cable core having a plurality of core pairs, each of said core pairs composed of two cores directly surrounded by a pair shielding, said pair shielding having a conductive exterior surrounding a core pair and being oriented outward; and
an overall shield surrounding said cable core and lying on said conductive exterior of said pair shielding and being thereby electrically connected to the said cable core.

2. The data cable according to claim 1, wherein said cores of said core pair run parallel to each other.

3. The data cable according to claim 1, wherein said pair shielding of said core pairs electrically contact each other in each case.

4. The data cable according to claim 1, wherein said core pairs are stranded together to form a stranded bundle.

5. The data cable according to claim 1, wherein said pair shielding is wound around a respective one of said core pairs.

6. The data cable according to claim 1, wherein said pair shielding of said core pairs are wound in a same direction.

7. The data cable according to claim 4, wherein said pair shielding of said core pairs are wound so as to run in a same direction as a stranding direction of said stranded bundle.

8. The data cable according to claim 4, wherein said pair shielding has a lay length being less than a lay length of said stranded bundle.

9. The data cable according to claim 1, wherein said pair shielding has a shielding foil.

10. The data cable according to claim 1, wherein for a purpose of realizing said pair shielding, a conductive sheath layer is formed.

11. The data cable according to claim 1, wherein said overall shield is selected from the group consisting of a braided shield, a spiral shield, a foil shield, and a combination thereof.

12. The data cable according to claim 1, wherein said cable core, besides having said core pairs, has at least one further element selected from the group consisting of filling strands, electrical supply lines, and electrical and/or optical data transmission elements.

13. The data cable according to claim 1, wherein a filler wire for shield contacting is omitted.

14. The data cable according to claim 1, wherein a foil that stabilizes and/or insulates the pair shielding is omitted.

15. The data cable according to claim 1, further comprising a connection element being contacted at one end, said connection element having a connection to a frame, which is connected to said overall shield.

16. The data cable according to claim 1, wherein said pair shielding is a shielding foil.

17. The data cable according to claim 10, wherein said conductive sheath layer is extruded-on.

18. A motor vehicle, comprising:
a data cable, containing:
a cable core having a plurality of core pairs, each of said core pairs composed of two cores directly surrounded by a pair shielding, said pair shielding having a conductive exterior surrounding a core pair and being oriented outward; and
an overall shield surrounding said cable core and lying on said conductive exterior of said pair shielding and being thereby electrically connected to the said cable core.

19. A method for producing a data cable, which comprises the steps of:
providing a plurality of core pairs;
wrapping a pair shielding having an outwardly oriented, conductive exterior to each of the core pairs;
applying an overall shield being electrically connected to the conductive exterior of the pair shielding; and
stranding the core pairs to form a stranded bundle, wherein a stranding direction of the stranded bundle and a winding direction of the pair shielding coincide.

20. The method according to claim 19, which further comprises forming the pair shielding in each case from a shielding foil and applying the shielding foil only during the stranding of the core pairs to form the stranded bundle, in that shielding foils are inserted concomitantly during the stranding process, without a separate banding process.
